(19) United States
(12) Patent Application Publication
(10) Pub. No.: US 2024/0134748 A1
(43) Pub. Date: Apr. 25, 2024

(54) BACKUP DATA ANALYSIS SYSTEM

(71) Applicant: Dell Products L.P., Round Rock, TX (US)

(72) Inventors: Chetan Pudiyanda Somaiah, Bangalore (IN); Hemal D. Shah, Bangalore (IN); Ravi Shankar Raja, Bangalore (IN); Navneet Upadhyay, Ghaziabad (IN)

(21) Appl. No.: 17/970,665

(22) Filed: Oct. 20, 2022

(51) Int. Cl. G06F 11/14; G06F 16/11

(52) U.S. Cl. CPC G06F 11/1448; G06F 16/116; G06F 2201/87

(57) ABSTRACT

A backup data analysis system includes a data generation subsystem that generates primary data, a primary data storage subsystem that stores the primary data, and a backup data storage subsystem that stores backup data that has a backup file format and that is a backup of the primary data. At least one backup data conversion/analytics data provisioning subsystem is coupled to a data analytics subsystem, an analytics data storage subsystem, and the backup data storage subsystem, and retrieves the backup data from the backup data storage subsystem, converts the backup data from the backup file format to an open file format to provide analytics data, and stores the analytics data in the analytics data storage subsystem. When the backup data conversion/analytics data provisioning subsystem(s) receive an analytics data request from the data analytics subsystem, they provide the analytics data to the analytics data subsystem for use in analytics operation(s).

### BACKGROUND

The present disclosure relates generally to information handling systems, and more particularly to providing for the analysis of backup data that was stored in order to primary data utilized by information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices, desktop computing devices, laptop/notebook computing devices, tablet computing device, mobile phones, and/or other computing devices known in the art, generate and/or utilize data that may be stored in a storage system provided in one or more locations that may include on-premise traditional storage infrastructure, virtualized storage infrastructures, network-connected “cloud” storage infrastructures, and/or other storage infrastructures that would be apparent to one of skill in the art in possession of the present disclosure. It is often desirable to perform data science operations and/or other data analytics operations on the data stored in a storage system like that discussed above, which can raise issues.

For example, conventional data science/analytics architectures must consider the hardware utilized in the storage system to physically store the data as well as the software utilized in the storage system to manage that data, while the design of the storage system will define how data is organized and accessed, and thus conventional data science/analytics systems may require custom configurations for the storage system with which they are used. While some conventional storage systems support data reporting and relatively simple data science/analytics operations, issues arise when there is a desire to perform relatively more robust data analysis, data modeling, and/or other data science operations. For example, conventional storage systems often generate and provide data from data sources to a “data warehouse” storage system, with data science/analytics systems coupled to the data warehouse storage system and configured to retrieve data from the data warehouse storage system to perform data science/analytics operations on that data. However, the data warehouse storage system is utilized by relatively high-priority operational processes for relatively critical data feeds, and those operational processes and their relatively critical data feeds from the data warehouse storage system take precedence over the use of the data in the data warehouse storage system for data science/analytics operations (which are often “last in line” with regard to the use of that data).

As a result, conventional data science/analytics systems are often not allowed to perform relatively intensive data science/analytics operations using the data in the data warehouse storage system, and instead must extract data samples from that data warehouse storage system and use those data samples to perform those relatively intensive data science/analytics operations “offline” or otherwise without utilizing bandwidth of the data warehouse storage system. As such, the data science/analytics operations often forgo the use of relatively “high-value” data, are limited to “in-memory” analytics, and/or suffer from other limitations that may be subject to the constraints of data sampling that can skew data science/analytics model accuracy and that prevent the performance of such data science/analytics operations on an entire/complete dataset that would otherwise provide relatively more accurate data science/analytics results. Furthermore, in situations in which the data science/analytics operations are performed on the data in the data warehouse storage system, the resulting load/bandwidth impacts on the data warehouse storage system can impact Service Level Agreements (SLAs) provided by the operational processes to customers, make those SLAs unpredictable, and/or result in other SLA issues known in the art.

As such, conventional data science/analytics systems are generally ad hoc and isolated from the data they utilize, preventing users from harnessing the power of advanced data science/analytics operations on their data, and regulating data science/analytics projects to non-standard initiatives that are frequently not aligned with corporate business goals or strategy. Thus, conventional data science/analytics suffer from relatively slow “time-to-insight” with respect to their data, and result in relatively lower business impacts than could be achieved if that data were relatively more accessible and supported by a data analysis infrastructure that facilitates relatively advanced data science/analytics operations.

Accordingly, it would be desirable to provide a data analysis system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a backup data conversion/analytics data provisioning engine that is configured to: retrieve, from a backup data storage subsystem, backup data that has a backup file format and that is a backup of primary data stored in a primary data storage subsystem; convert the backup data from the backup file format to an open file format to provide analytics data; store the analytics data in an analytics data storage subsystem; receive, from a data analytics subsystem, an data analytics request; and provide, to the data analytics subsystem in response to receiving the data analytics request, the analytics data.

### BRIEF DESCRIPTION OF THE DRAWINGS

FIG. 1 is a schematic view illustrating an embodiment of an Information Handling System (IHS).

FIG. 2 is a schematic view illustrating an embodiment of backup data analysis system that may be provided according to the teachings of the present disclosure.

FIG. 3 is a schematic view illustrating an embodiment of a user system that may be included in the backup data analysis system of FIG. 2.

FIG. 4 is a schematic view illustrating an embodiment of a backup data conversion/analytics data provisioning system that may be included in the backup data analysis system of FIG. 2.

FIG. 5 is a schematic view illustrating an embodiment of the user system of FIG. 3 and the backup data conversion/analytics data provisioning system of FIG. 4 providing a backup data analysis system according to the teachings of the present disclosure.

FIG. 6 is a flow chart illustrating an embodiment of a method for providing backup data analysis.

FIG. 7 is a schematic view illustrating an embodiment of the backup data analysis system of FIG. 5 operating during the method of FIG. 7.

FIG. 8 is a schematic view illustrating an embodiment of the backup data analysis system of FIG. 5 operating during the method of FIG. 7.

FIG. 9 is a schematic view illustrating an embodiment of the backup data analysis system of FIG. 5 operating during the method of FIG. 7.

FIG. 10 is a schematic view illustrating an embodiment of the backup data analysis system of FIG. 5 operating during the method of FIG. 7.

FIG. 11 is a schematic view illustrating an embodiment of the backup data analysis system of FIG. 5 operating during the method of FIG. 7.

FIG. 12 is a schematic view illustrating an embodiment of the backup data analysis system of FIG. 5 operating during the method of FIG. 7.

FIG. 13 is a schematic view illustrating an embodiment of the backup data analysis system of FIG. 5 operating during the method of FIG. 7.

FIG. 14 is a schematic view illustrating an embodiment of the backup data analysis system of FIG. 5 operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

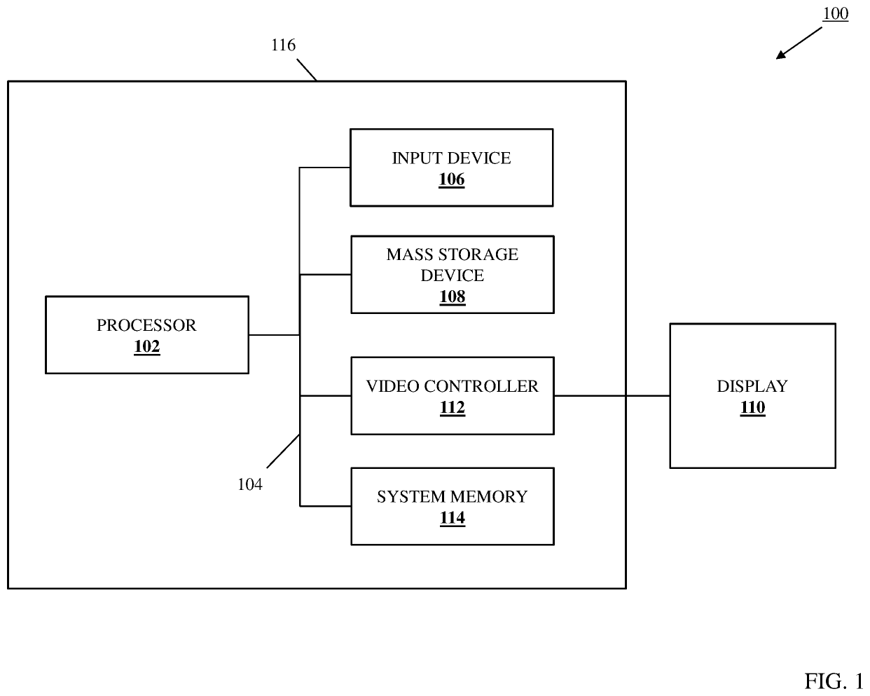

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

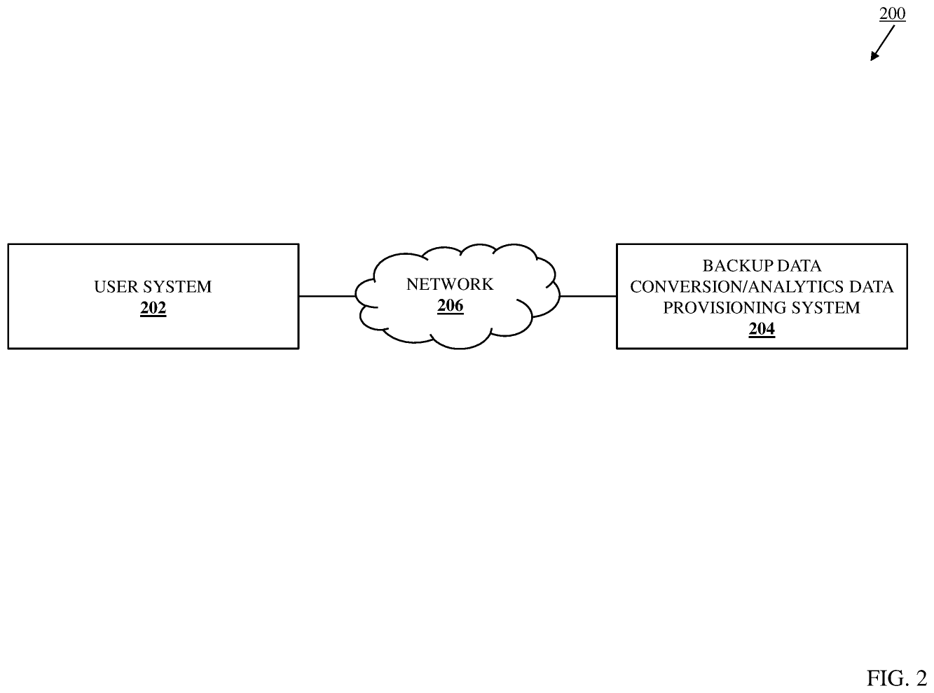

Referring now to FIG. 2, an embodiment of a backup data analysis system 200 is illustrated that may be provided according to the teachings of the present disclosure. In the illustrated embodiment, the backup data analysis system 200 includes a user system 202. In an embodiment, the user system 202 may be provided by one or more of the IHS 100 discussed above with reference to FIG. 1, and/or may include some or all of the components of the IHS 100, and in specific examples may be provided by storage systems, server devices, desktop computing devices, laptop/notebook computing devices, tablet computing device, mobile phones, and/or other computing and storage devices that one of skill in the art in possession of the present disclosure would recognize as generating and storing the relatively large amounts of data that are subject to the backup operations and analytics operations discussed below. However, while illustrated and discussed as provided by particular computing and storage devices and generating and storing relatively large amounts of data, one of skill in the art in possession of the present disclosure will recognize that the user system 202 may include any computing and storage devices that may be configured to generate and store any amounts of data for backup operations and analytics operations while remaining within the scope of the present disclosure as well.

The backup data analysis system 200 also includes a backup data conversion/analytics data provisioning system 204. In an embodiment, the backup data conversion/analytics data provisioning system 204 may be provided by one or more of the IHS 100 discussed above with reference to FIG. 1, and/or may include some or all of the components of the IHS 100, and in specific examples may be provided by server devices and storage systems. However, while illustrated and discussed as provided by particular computing and storage devices, one of skill in the art in possession of the present disclosure will recognize that the backup data conversion/analytics data provisioning system 204 may include any computing and storage devices that are configured to perform the functionality of the backup data conversion/analytics data provisioning system discussed below while remaining within the scope of the present disclosure as well.

In the illustrated embodiment, the user system 202 is coupled to a backup data conversion/analytics data provisioning system 204 via a network 206 that may be provided by a Local Area Network (LAN), the Internet, combinations thereof, and/or any other network that would be apparent to one of skill in the art in possession of the present disclosure. However, as discussed below, other embodiments of the present disclosure may omit the network 206 and/or provide the network 206 between other components of the user backup data analysis system 200 in order to, for example, implement the backup data analysis system 200 with the user system 202 and backup data conversion/analytics data provisioning system 204 integrated. For example, embodiments of the backup data analysis system 200 like that illustrated in FIG. 2 may provide the backup data conversion/analytics data provisioning functionality of the backup data conversion/analytics data provisioning system 204 as a network-accessible service to the user system 202 (and other user systems that are not illustrated but that may operate similarly as the user system 202 discussed below). However, in other embodiments, the backup data analysis system 200 may integrate the backup data conversion/analytics data provisioning functionality of the backup data conversion/analytics data provisioning system 204 in the user system 202 in order to allow the user system 202 to back up their data and perform data analytics on that data in the manner described below. As such, while a specific backup data analysis system 200 has been illustrated and described, one of skill in the art in possession of the present disclosure will recognize that the system of the present disclosure may include a variety of components and component configurations while remaining within the scope of the present disclosure as well.

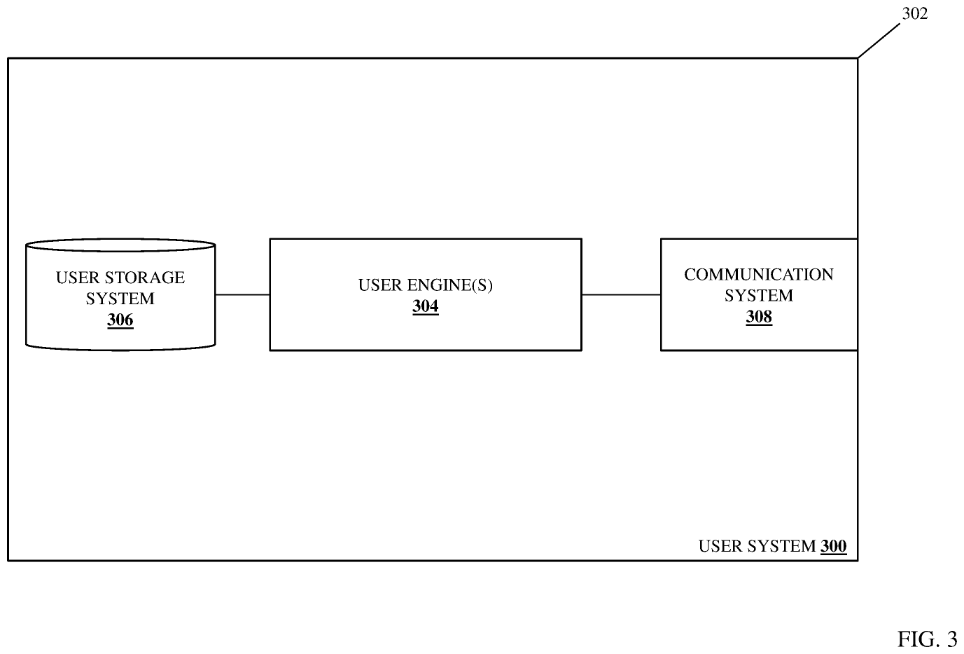

Referring now to FIG. 3, an embodiment of a user system 300 is illustrated that may provide the user system 202 discussed above with reference to FIG. 2. As such, the user system 300 may be provided by one or more of the IHS 100 discussed above with reference to FIG. 1 and/or may include some or all of the components of the IHS 100, and in specific examples may be provided by storage systems, server devices, desktop computing devices, laptop/notebook computing devices, tablet computing device, mobile phones, and/or other computing and storage devices that one of skill in the art in possession of the present disclosure would recognize as generating and storing the relatively large amounts of data that are subject to the backup operations and analytics operations discussed below. However, while illustrated and discussed as provided by particular computing and storage devices and generating and storing relatively large amounts of data, one of skill in the art in possession of the present disclosure will recognize that the user system 300 may include any computing and storage devices that may be configured to generate and store any amounts of data for backup operations and analytics operations while remaining within the scope of the present disclosure as well.

In the illustrated embodiment, the user system 300 includes one or more chassis 302 that house the components of the user system 300, only some of which are illustrated and described below. For example, the chassis 302 may house a processing system (not illustrated, but which may include one or more of the processor 102 discussed above with reference to FIG. 1) and a memory system (not illustrated, but which may include one or more of the memory 114 discussed above with reference to FIG. 1) that is coupled to the processing system and that includes instructions that, when executed by the processing system, cause the processing system to provide one or more user engines 304 that are configured to perform the functionality of the user engines and/or user systems discussed below.

The chassis 302 may also house a user storage system 306 (e.g., which may include the storage 108 discussed above with reference to FIG. 1) that is coupled to the user engine(s) 304 (e.g., via a coupling between the user storage system 306 and the processing system). The chassis 302 may also house a communication system 308 that is coupled to the user engine(s) 304 (e.g., via a coupling between the communication system 308 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. However, while a specific user system 300 has been illustrated and described, one of skill in the art in possession of the present disclosure will recognize that user systems (or other devices operating according to the teachings of the present disclosure in a manner similar to that described below for the user system 300) may include a variety of components and/or component configurations for providing conventional user system functionality, as well as the functionality discussed below, while remaining within the scope of the present disclosure as well.

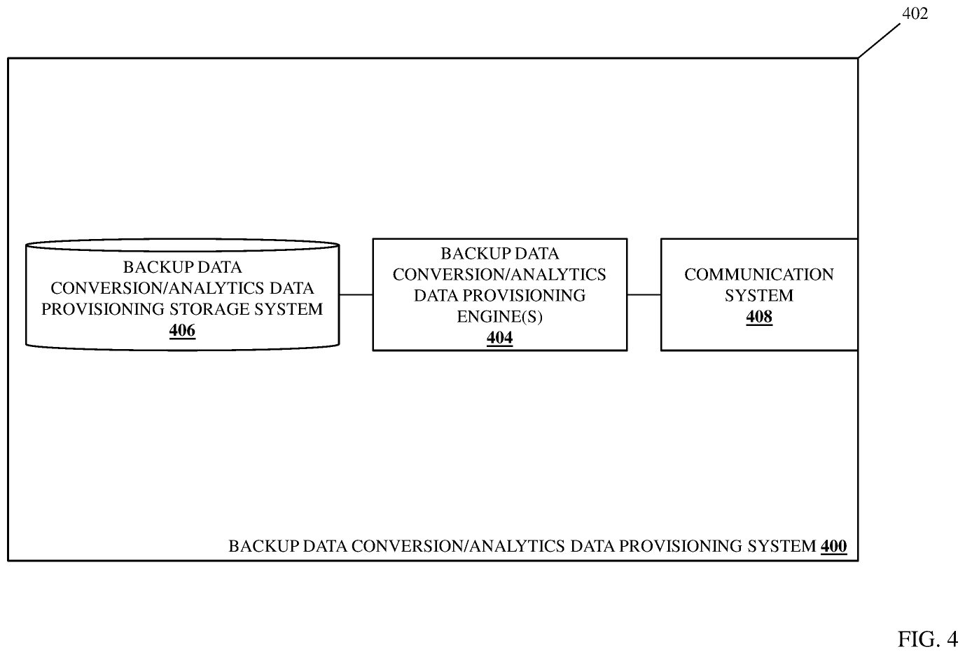

Referring now to FIG. 4, an embodiment of a backup data conversion/analytics data provisioning system 400 is illustrated that may provide the backup data conversion/analytics data provisioning system 204 discussed above with reference to FIG. 2. As such, the backup data conversion/analytics data provisioning system 400 may be provided by one or more of the IHS 100 discussed above with reference to FIG. 1 and/or may include some or all of the components of the IHS 100, and in specific examples may be provided by server devices and storage systems. However, while illustrated and discussed as provided by particular computing and storage devices, one of skill in the art in possession of the present disclosure will recognize that the backup data conversion/analytics data provisioning system 400 may include any computing and storage devices that that are configured to perform the functionality of the backup data conversion/analytics data provisioning system 400 discussed below while remaining within the scope of the present disclosure as well.

In the illustrated embodiment, the backup data conversion/analytics data provisioning system 400 includes one or more chassis 402 that house the components of the backup data conversion/analytics data provisioning system 400, only some of which are illustrated and described below. For example, the chassis 402 may house a processing system (not illustrated, but which may include one or more of the processor 102 discussed above with reference to FIG. 1) and a memory system (not illustrated, but which may include one or more of the memory 114 discussed above with reference to FIG. 1) that is coupled to the processing system and that includes instructions that, when executed by the processing system, cause the processing system to provide one or more backup data conversion/analytics data provisioning engines 404 that are configured to perform the functionality of the backup data conversion/analytics data provisioning engines and/or backup data conversion/analytics data provisioning systems discussed below.

The chassis 402 may also house a backup data conversion/analytics data provisioning storage system 406 (e.g., which may include the storage 108 discussed above with reference to FIG. 1) that is coupled to the backup data conversion/analytics data provisioning engine(s) 404 (e.g., via a coupling between the backup data conversion/analytics data provisioning storage system 406 and the processing system). The chassis 402 may also house a communication system 408 that is coupled to the backup data conversion/analytics data provisioning engine(s) 404 (e.g., via a coupling between the communication system 408 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. However, while a specific backup data conversion/analytics data provisioning system 400 has been illustrated and described, one of skill in the art in possession of the present disclosure will recognize that backup data conversion/analytics data provisioning systems (or other devices operating according to the teachings of the present disclosure in a manner similar to that described below for the backup data conversion/analytics data provisioning system 400) may include a variety of components and/or component configurations for providing conventional backup and/or analytics functionality, as well as the functionality discussed below, while remaining within the scope of the present disclosure as well.

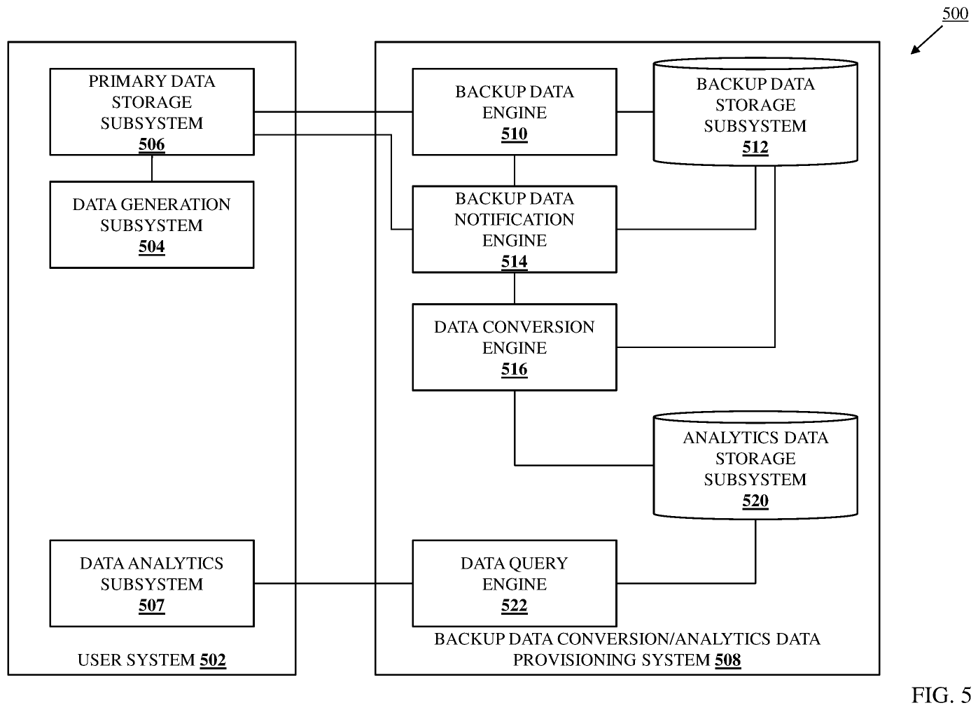

With reference to FIG. 5, an embodiment of a backup data analysis system 500 is illustrated that may be provided according to the teachings of the present disclosure using the user system 202/300 and the backup data conversion/analytics data provisioning system 204/400 described above. The backup data analysis system 500 includes a user system 502 that may be provided by the user system 202 and/or 300 discussed above with reference to FIGS. 2 and 3. In the illustrated embodiment, the user system 502 includes a data generation subsystem 504 such as a data generation engine that may be provided by the user engine(s) 304 discussed above, and a primary data storage subsystem 506 that may be provided by the user storage system 306 discussed above. In a specific example, the primary data storage subsystem 506 may utilize ORACLE® databases available from ORACLE® corporation of Austin, Texas, United States; MICROSOFT Structured Query Language (SQL)® databases available from MICROSOFT® corporation of Redmond, Washington, United States; and/or other databases that would be apparent to one of skill in the art in possession of the present disclosure.

As discussed in further detail below, the data generation subsystem 504 may be configured to generate “primary data” (e.g., that may be distinguished from “backup data” and “analytics data” that may include the same or similar information but a different file format as discussed below) and store that primary data in the primary data storage subsystem 506. To provide a specific example, the data generation subsystem 504 may be configured to generate primary data with “primary” file formats that are utilized by computing devices in the user system 502 to consume that data and that may include a “.doc” file format, a “.ppt” file format, a “.xls” file format, a “.jpg” file format, a “.pdf” file format, and/or any other primary file formats that would be apparent to one of skill in the art in possession of the present disclosure, and store that primary data in the primary data storage subsystem 506.

In the illustrated embodiment, the user system 502 also includes a data analytics subsystem 507 such as a data analytics engine that may be provided by the user engine(s) 304 discussed above and that may be configured to perform any of a variety of data science operations and/or other data analytics operations that would be apparent to one of skill in the art in possession of the present disclosure. Furthermore, while the data analytics subsystem 507 is illustrated and described below as being integrated in the user system 502, one of skill in the art in possession of the present disclosure will appreciate that the data analytics subsystem of the present disclosure may be separate from the user system 502 while remaining within the scope of the present disclosure as well. For example, in some embodiments the data analytics subsystem 507 may be controlled by a data analytics entity that is separate from the user entity that controls the user system 502, and the user entity may outsource the data analytic operations on their data to the data analytics entity. Furthermore, in other embodiments, the data analytics subsystem 507 may be controlled by a backup data conversion/analytics data provisioning entity that also controls the backup data conversion/analytics data provisioning system 508 that is coupled to the user system 502, rather than by the user entity as described above and illustrated in FIG. 5.

The backup data conversion/analytics data provisioning system 508 may be provided by the backup data conversion/analytics data provisioning system 204 and/or 400 discussed above with reference to FIGS. 2 and 4. In the illustrated embodiment, the backup data conversion/analytics data provisioning system 508 includes a backup data engine 510 or other backup data subsystem that may be provided by the backup data conversion/analytics data provisioning engine(s) 404 discussed above, and a backup data storage subsystem 512 that may be provided by the backup data conversion/analytics data provisioning storage system 406 discussed above. As illustrated, the backup data engine 510 may be coupled to the primary data storage subsystem 506 in the user system 502 (e.g., directly, via the network 206 discussed above, and/or in any other manner that would be apparent to one of skill in the art in possession of the present disclosure). As discussed in further detail below, the backup data engine 510 may be configured to retrieve or receive “backup data” (e.g., that may be distinguished from “primary data” and “analytics data” that may include the same or similar information but a different file format as discussed below) and store that backup data in the backup data storage subsystem 512. To provide a specific example, the backup data engine 510 may be configured to receive backup data with a “backup” file format that may include a “.bak” file format and/or any other backup file formats that would be apparent to one of skill in the art in possession of the present disclosure, and store that backup data in the backup data storage subsystem 512.

In the illustrated embodiment, the backup data conversion/analytics data provisioning system 508 also includes a backup data notification engine 514 or other backup data notification subsystem that may be provided by the backup data conversion/analytics data provisioning engine(s) 404 discussed above, and that is coupled to each of the backup data engine 510 and the backup data storage subsystem 512. As illustrated, the backup data notification engine 514 may be coupled to the primary data storage subsystem 506 in the user system 502 as well (e.g., directly, via the network 206 discussed above, and/or in any other manner that would be apparent to one of skill in the art in possession of the present disclosure). As discussed in further detail below, the backup data notification engine 514 may be configured to monitor the backup data engine 510 and/or the backup data storage subsystem 512 to identify and notify when backup data has been stored, updated, and/or otherwise provided in the backup data storage subsystem 512, monitor the primary data storage subsystem 506 to identify and notify when primary data has been stored, updated, and/or otherwise provided in the primary data storage subsystem 506 so that corresponding analytics data may be updated as well, and/or perform any of the other functionality described below. In a specific example, the backup data notification engine 514 may be configured via a “cron” command-line utility to schedule a backup data notification job (e.g., a “cron job”) that is configured to perform the backup data notification operations described herein. However, while a specific example has been described, one of skill in the art in possession of the present disclosure will appreciate how the backup data notification operations described herein may be performed using other techniques while remaining within the scope of the present disclosure as well.

In the illustrated embodiment, the backup data conversion/analytics data provisioning system 508 also includes a data conversion engine 516 or other data conversion subsystem that may be provided by the backup data conversion/analytics data provisioning engine(s) 404 discussed above, and that is coupled to each of the backup data notification engine 514 and the backup data storage subsystem 512. As discussed in further detail below, the data conversion engine 516 may be configured to convert backup data to analytics data. To provide a specific example, the data conversion engine 516 may be configured to retrieve the backup data stored in the backup data storage subsystem 512 with the “backup” file format that may include a “.bak” file format and/or any other backup file formats that would be apparent to one of skill in the art in possession of the present disclosure, and convert that backup data to an open file format that may include a .parquet file format that is utilized by APACHE® PARQUET® open-source software and that provides a column-oriented data file format designed for efficient data storage and retrieval, and/or any other open file formats that would be apparent to one of skill in the art in possession of the present disclosure. As discussed below, the conversion of the backup data from the backup file format to the open file format provides “analytics data” (e.g., that may be distinguished from “primary data” and “backup data” that may include the same information but a different file format as discussed below) that may be stored by the data conversion engine 516 as described below.

In the illustrated embodiment, the backup data conversion/analytics data provisioning system 508 includes an analytics data storage subsystem 520 that may be provided by the backup data conversion/analytics data provisioning storage system 406 discussed above, and that is coupled to the data conversion engine 516. As discussed in further detail below, the analytics data storage subsystem 520 may be configured to store the “analytics data” provided by the data conversion engine 516. In the illustrated embodiment, the backup data conversion/analytics data provisioning system 508 also includes a data query engine 522 or other data query subsystem that may be provided by the backup data conversion/analytics data provisioning engine(s) 404 discussed above, that is coupled to the analytics data storage subsystem 520, and that is coupled to the data analytics subsystem 507 in the user system 502 (e.g., directly, via the network 206 discussed above, and/or in any other manner that would be apparent to one of skill in the art in possession of the present disclosure). As discussed in further detail below, the data query engine 406 may be configured to receive data analytics queries and/or other analytics requests, and satisfy those analytics requests by retrieving analytics data stored in the analytics data storage subsystem 502 and providing that analytics data to the data analytics subsystem 507. However, while a specific backup data analysis system 500 has been illustrated and described, one of skill in the art in possession of the present disclosure will appreciate that a wide variety of modification to the backup data analysis system 500 discussed in the examples provided below will fall within the scope of the present disclosure.

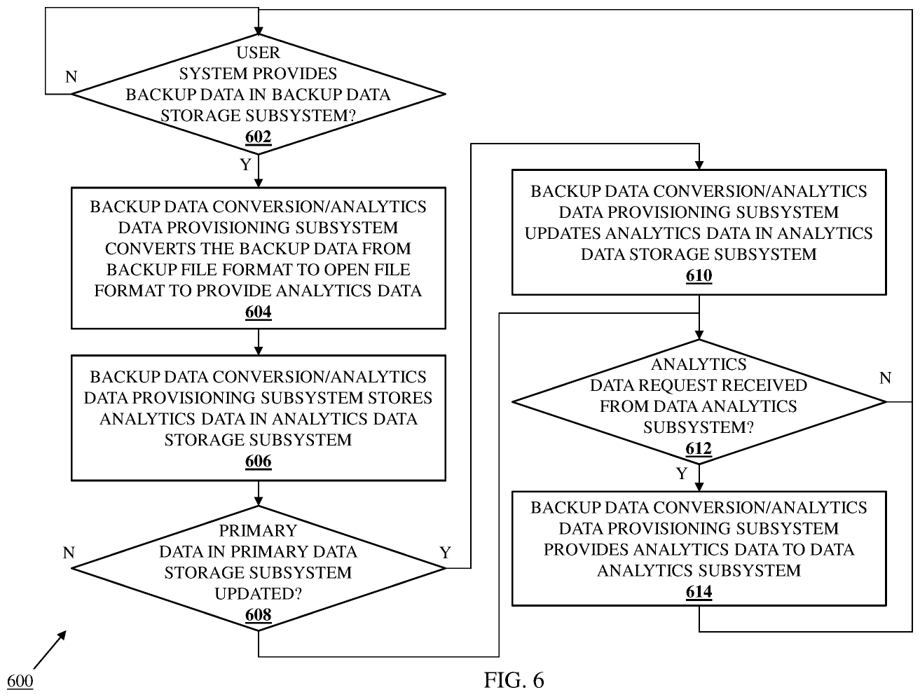

Referring now to FIG. 6, an embodiment of a method 600 for providing backup data analysis is illustrated. As discussed below, the systems and methods of the present disclosure provide for the conversion of backup data, which is stored in a backup data storage subsystem in order to back up primary data stored in a primary data storage subsystem, to analytics data that is stored in an analytics data storage subsystem for use in performing analytics operations. For example, the backup data analysis system of the present disclosure may include a data generation subsystem that generates primary data, a primary data storage subsystem that stores the primary data, and a backup data storage subsystem that stores backup data that has a backup file format and that is a backup of the primary data. At least one backup data conversion/analytics data provisioning subsystem is coupled to a data analytics subsystem, an analytics data storage subsystem, and the backup data storage subsystem, and retrieves the backup data from the backup data storage subsystem, converts the backup data from the backup file format to an open file format to provide analytics data, and stores the analytics data in the analytics data storage subsystem. When the backup data conversion/analytics data provisioning subsystem(s) receive an analytics data request from the data analytics subsystem, they provide the analytics data to the analytics data subsystem for use in analytics operation(s). As such, backup data that includes a entire/complete copy of primary data in a user system may be utilized in analytics operations to increase the accuracy and value of corresponding analytics, while not effecting the use of the primary data in the user system.

The method 600 begins at decision block 602 where it is determined whether a user system has provided backup data in a backup data storage subsystem. In an embodiment, at decision block 602, the backup data notification engine 514 in the backup data conversion/analytics data provisioning system 508 may monitor the backup data engine 510 and/or the backup data storage subsystem 512 in order to determine whether the user system 502 has provided backup data in the backup data storage subsystem 512. As discussed in further detail below, different embodiments of the present disclosure may include the user system 502 providing backup data in the backup data storage subsystem 512 as a full backup of primary data stored in the primary data storage subsystem 506, as a partial backup of primary data stored in the primary data storage subsystem 506, as a backup update of the backup data stored in the backup data storage subsystem 512 in response to a primary update of the primary data stored in the primary data storage subsystem 506, and/or as part of any other backup data provisioning operations that one of skill in the art in possession of the present disclosure will recognized may be identified by the backup data notification engine 514.

If, at decision block 602, it is determined that the user system has not provided backup data in the backup data storage subsystem, the method 600 returns to decision block 602. As such, the method 600 may loop such that the backup data notification engine 514 in the backup data conversion/analytics data provisioning system 508 continues to monitor the backup data engine 510 and/or the backup data storage subsystem 512 until the user system 502 provides backup data in the backup data storage subsystem 512.

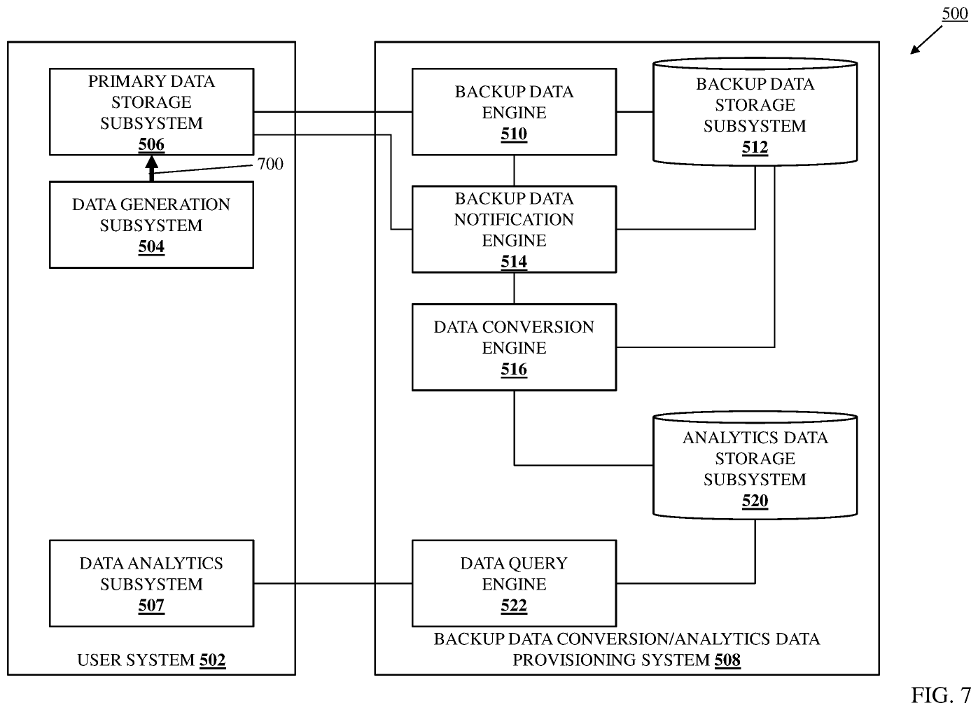

With reference to FIG. 7, in an embodiment of decision block 602, the data generation subsystem 504 in the user system 502 may perform data generation and storage operations 700 that may include generating primary data and storing that primary data in the primary data storage subsystem 506. In a specific example, at decision block 602, the data generation subsystem 504 may generate primary data with primary file formats that are utilized by computing devices in the user system 502 to consume that data and that may include a “.doc” file format, a “.ppt” file format, a “.xls” file format, a “.jpg” file format, a “.pdf” file format, and/or any other primary file formats that would be apparent to one of skill in the art in possession of the present disclosure, and store that data in the primary data storage subsystem 506. As will be appreciated by one of skill in the art in possession of the present disclosure, the data generation and storage operations 700 may be performed repeatedly over time by any of a variety of data generations subsystems in the user system 502 in order provide to generate and store, update, and/or otherwise provide the primary data in the primary data storage subsystem 506.

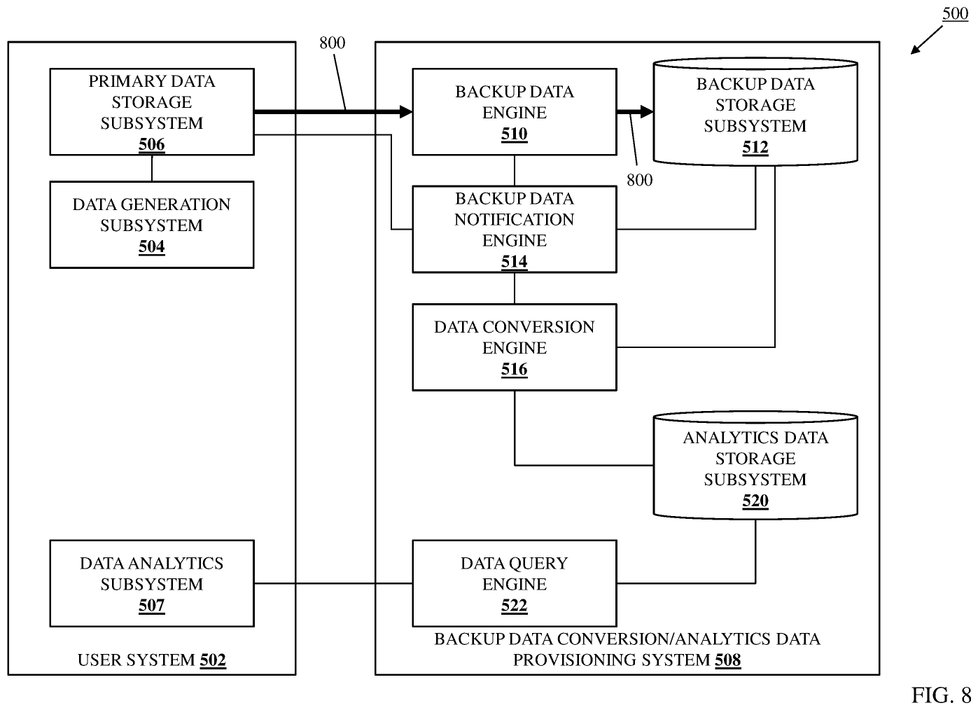

With reference to FIG. 8, in an embodiment of decision block 602, the backup data engine 510 in the backup data conversion/analytics data provisioning system 508 may perform primary data backup operations 800 that may include receiving backup data from the primary data storage subsystem 506, and storing that backup data in the backup data storage subsystem 512. For example, as discussed above, the primary data storage subsystem 506 may be configured to convert primary data that is stored in the primary data storage subsystem 506 to backup data, and then transmit that backup data to the backup data engine 510 for storage in the backup data storage subsystem 512. As such, and continuing with the specific examples provided above, at decision block 602 the primary data storage subsystem 506 may perform any of a variety of backup data generation operations known in the art that may include converting primary data that is stored in the primary data storage subsystem 506 in a primary file format to a backup file format such as the “.bak” file format discussed above in order to provide backup data for that primary data (e.g., with that primary data and corresponding backup data including the same or similar information stored in different file formats), and then provide that backup data to the backup data engine 510.

In some embodiments, the primary data backup operations 800 may be initiated manually (e.g., by a user), on a schedule in order to back up the primary data stored in the primary data storage subsystem 506 regularly (e.g., weekly, daily, hourly, etc.), and/or using other conventional data backup techniques that would be apparent to one of skill in the art in possession of the present disclosure. However, in other embodiments, the primary data backup operations 800 may be initiated by the backup data conversion/analytics data provisioning system 508. As will be appreciated by one of skill in the art in possession of the present disclosure, some primary data storage subsystems (e.g., those utilizing the MICROSOFT SQL® databases discussed above) allow the backup-data-to-analytics-data conversion operations discussed below without a need to update the backup data stored in the backup data storage subsystem 512, and thus backup data used at subsequent blocks of the method 600 may be stored in the backup data storage subsystem 512 via the manual, scheduled, and/or other backup operations discussed above.

However, other primary data storage subsystems (e.g., those utilizing the ORACLE® databases discussed above) may require an update of the backup data stored in the backup data storage subsystem 512 (e.g., a “full restore” backup data operation) in order to perform the backup-data-to-analytics-data conversion operations discussed below, and such backup data updates may also be performed periodically to avoid data drift, when Data Manipulation Language (DML) queries alter data structures (e.g., column additions, column type updates, etc.), and/or in other situations that would be apparent to one of skill in the art in possession of the present disclosure. As such, some embodiments of the present disclosure may include the backup data conversion/analytics data provisioning system 508 initiating the primary data backup operations 800 in order to update the backup data stored in the backup data storage subsystem 512 for use in the subsequent blocks of the method 600. To provide a specific example, the backup data notification engine 514 in the backup data conversion/analytics data provisioning system 508 may include a “cron job” to initiate the primary data backup operations 800. However, while a few specific examples of the initiation of the primary data backup operations 800 have been described, one of skill in the art in possession of the present disclosure will appreciate how primary data may be backed up as backup data for a variety of reasons and using a variety of techniques while remaining within the scope of the present disclosure as well.

As such, at decision block 602, the backup data notification engine 514 in the backup data conversion/analytics data provisioning system 508 may be configured to determine that the user system 502 has provided backup data in the backup data storage subsystem 512 in response to receiving a notification from the backup data engine 510 (e.g., in response to the backup data engine 510 receiving the backup data from the primary data storage subsystem 506 as described above), in response to detecting the storage of that backup data in the backup data storage subsystem 512, in response to initiating the primary data backup operations 800, and/or based on any other backup data provisioning/storage techniques that would be apparent to one of skill in the art in possession of the present disclosure.

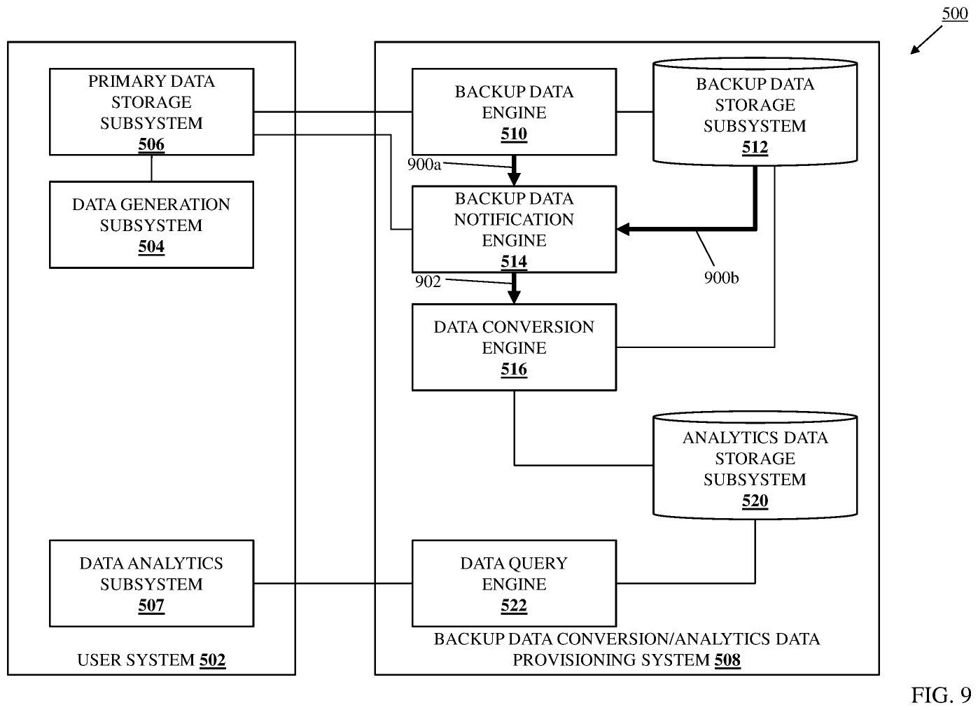

If, at decision block 602, it is determined that the user system has provided backup data in a backup data storage subsystem, the method 600 proceeds to block 604 where a backup data conversion/analytics data provisioning subsystem converts the backup data from a backup file format to an open file format to provide analytics data. With reference to FIG. 9, in an embodiment of decision block 602, the backup data notification engine 514 may perform backup data provisioning identification operations that include identifying that the user system 502 has provided backup data in the backup data storage subsystem 512, which as discussed above may include receiving a backup data provisioning notification 900a from the backup data engine 510, performing backup data storage subsystem monitoring operations 900b that include detecting the provisioning of backup data in the backup data storage subsystem 512, initiating the primary data backup operations 800, and/or using other backup data provisioning identification techniques that would be apparent to one of skill in the art in possession of the present disclosure. In response to determining that the user system 502 has provided backup data in the backup data storage subsystem 512, the backup data notification engine 514 may perform backup data notification operations 902 that include notifying the data conversion engine 516 that the backup data was provided in the backup data storage subsystem 512.

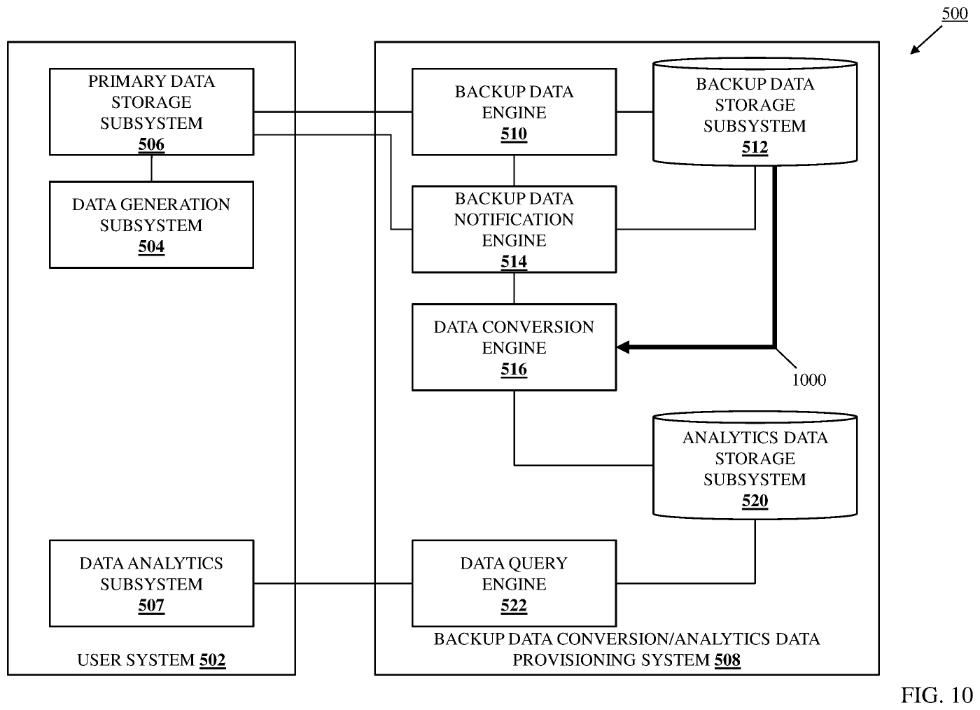

With reference to FIG. 10, in an embodiment of block 604 and in response to receiving the notification that the backup data was provided in the backup data storage subsystem 512, the data conversion engine 516 may perform backup data retrieval operations 1000 that include retrieving the backup data from the backup data storage subsystem 512. For example, the backup data retrieval operations 1000 performed by the data conversion engine 516 may include the use of an Application Programming Interface (API) call to read the backup data directly (e.g., backup data stored in the backup data storage subsystem 512 in MONGODB® Binary JavaScript Object Notation (JSON) (BSON) files), copy the backup data from the backup data storage subsystem 512 to a temporary database included in or accessible to the data conversion engine 516, and/or perform other backup data retrieval operations that would be apparent to one of skill in the art in possession of the present disclosure. However, while the data conversion engine 516 is illustrated and described as retrieving the backup data from the backup data storage subsystem 512, one of skill in the art in possession of the present disclosure will appreciate how the data conversion engine 516 may receive the backup data that is stored in the backup data storage subsystem 512 from the backup data notification engine 514, the backup data storage subsystem 512, and/or using other backup data retrieval techniques that would be apparent to one of skill in the art in possession of the present disclosure.

In response to retrieving or receiving the backup data, the data conversion engine 516 may then perform backup-data-to-analytics-data conversion operations that include converting the backup data to analytics data. Continuing with the examples provided above, the backup data may have the “backup” file format (e.g., a “.bak” file format), and at block 604 the backup-data-to-analytics-data conversion operations performed by the data conversion engine 516 may include converting that backup data to an open file format (e.g., a “.parquet” file format) in order to provide analytics data. As will be appreciated by one of skill in the art in possession of the present disclosure, backup file formats such as the “.bak” file format may provide the backup data as “0's” and “1's” in rows and columns of tables, and metadata included in the file in which the backup data is stored (e.g., metadata that identifies a number of tables, a number of columns in each table, a number of rows in each table, etc.) may be utilized in the conversion of the backup data to the analytics data. In a specific example, the backup-data-to-analytics-data conversion operations may include converting the backup data from the backup file format (“.bak”) to an comma separated value (“.csv”) file format to provide intermediate data, and then converting that intermediate data from the comma separated value (“.csv”) file format to an open file format (“.parquet”) to provide the analytics data.

Continuing with the specific example in which the backup data is converted to the intermediate data with the comma separated value (“.csv”) file format that is then converted to the analytics data, the data conversion engine 516 may extract the backup data by directly reading that backup data from the file(s) (e.g., the MONGODB® BSON files discussed above) in the backup data storage subsystem 512 and providing it in a comma separated value (“.csv”) file having the comma separated value (“.csv”) file format, or by exporting the backup data that was copied to the temporary database as discussed above to a comma separated value (“.csv”) file having the comma separated value (“.csv”) file format. As will be appreciated by one of skill in the art in possession of the present disclosure, the provisioning of the intermediate data in such a manner may include extracting metadata from the file that includes backup data, building a data catalog, and exporting the backup data to the comma separated value (“.csv”) file to provide the intermediate data. However, such operations presume a readable file that include the backup data, and in situations in which the file that includes the backup data is not readable, that file may be restored in a temporary database, queries may be run to extract the metadata from that file, the data catalog may be built, and queries may be run to export that backup data to the comma separated value (“.csv”) file to provide the intermediate data.

Continuing with this specific example, the intermediate data provided in comma separate value (“.csv”) file(s) may be converted to the open file format via a SPARK® job provided by APACHE® SPARK® PARQUET® open-source software that converts the intermediate data into analytics data that is provided in a table provided by an open table format such as an ICEBERG® table having an ICEBERG® table format that is provided by APACHE® ICEBERG® open-source software and that utilizes the “.parquet” file format/open file format discussed above (e.g., the ICEBERG® table format defaults to the “.parquet” file format in conventional ICEBERG® table systems). As will be appreciated by one of skill in the art in possession of the present disclosure, the ICEBERG® table(s) having the ICEBERG® table format that store the analytics data with the “.parquet” file format/open file format may include metadata and/or other details about the analytics data such as a number of tables ingested, a number of rows ingested, data quality, and/or other data characteristics that one of skill in the art in possession of the present disclosure will appreciate will allow the analytics data to be ingested relatively quicker and easier than without such metadata and/or other details. However, while specific techniques and data conversion tools have been discussed as being used to convert backup data to particular analytics data having a particular open file format, one of skill in the art in possession of the present disclosure will appreciate how backup data may be converted to analytics data having other open file formats that allow the access to the analytics data discussed below and the performance of the analytics operations discussed below while remaining within the scope of the present disclosure as well.

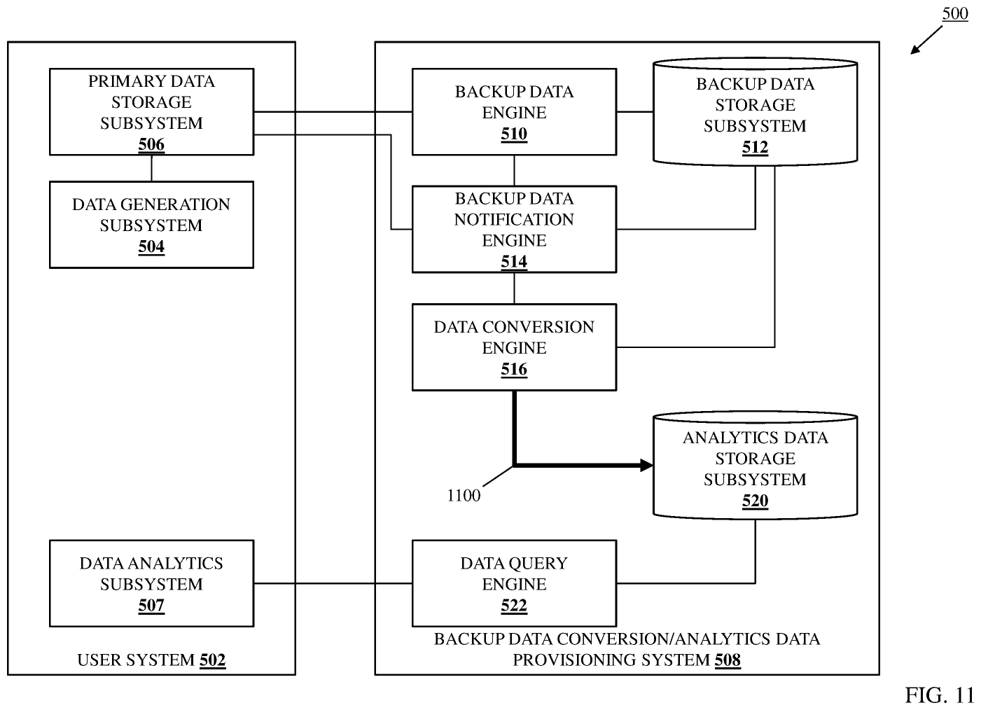

The method 600 then proceeds to block 606 where the backup data conversion/analytics data provisioning subsystem stores analytics data in an analytics data storage subsystem. With reference to FIG. 11, in an embodiment of block 606 and subsequent to the conversion of the backup data to the analytics data, the data conversion engine 516 in the backup data conversion/analytics data provisioning system 508 may perform analytics data storage operations 1100 that may include storing the analytics data in the analytics data storage subsystem 520. Continuing with the specific examples provided above, the storage of the analytics data in the analytics data storage subsystem 520 may include determining whether an ICEBERG® table for that analytics data exists in the analytics data storage subsystem 520 and, if so, merging that analytics data (e.g., ICEBERG® files including that analytics data) in those ICEBERG® tables, while if not, providing that analytics data in a temporary storage or other database until an ICEBERG® table is created for it. In some embodiments, the storage of the analytics data in the analytics data storage subsystem 520 may include maintaining a data catalog for the analytics data/analytics data storage subsystem 520 that identifies relationships between tables and columns of the analytics data, which one of skill in the art in possession of the present disclosure will appreciate may allow the generation of “blacklists” and/or “whitelists” of tables and/or columns that may be used to prevent or allow access to analytics data (e.g., Personal Identification Information (PII) fields in the analytics data may be blacklisted to prevent access to that data during analytics operations).

As will be appreciated by one of skill in the art in possession of the present disclosure, the conversion of the backup data to analytics data having the open file format such as the ICEBERG® table format that stores the analytics data with the “.parquet” file format discussed above allows data analytics applications and/or other subsystems (e.g., the data analytics subsystem 507 that is configured to utilize such open file formats) to access and process that data during analytics operations, discussed in further detail below. Furthermore, one of skill in the art in possession of the present disclosure will appreciate how blocks 604 and 606 of the method 600 may be performed to provide the open-architecture storage pool of analytics data in the analytics data storage subsystem 520 described above without interrupting any usage of the primary data storage subsystem 506 or other “production” databases utilized in the user system 502.

The method 600 then proceeds to decision block 608 where it is determined whether primary data in the primary data storage subsystem is updated. In an embodiment, at decision block 608, the backup data notification engine 514 in the backup data conversion/analytics data provisioning system 508 may operate to determine whether the primary data in the primary data storage subsystem 506 that corresponds to the analytics data that was stored in the analytics data storage subsystem 520 has been updated. As discussed below, the backup data conversion/analytics data provisioning system 508 may be configured to provide updates to the analytics data stored in the analytics data storage subsystem 520 in response to corresponding updates of the primary data in the primary data storage subsystem 506, and thus may be configured to communicate with, access, and/or otherwise interface with the primary data storage subsystem 506 in the user system 502 in order to enable such analytics data updates.

For example, the primary data storage subsystem 506 may be configured with a Change Data Capture (CDC) subsystem (e.g., a CDC subsystem that is integrated with the databases provided by the primary storage subsystem 506), and the backup data notification engine 514 in the backup data conversion/analytics data provisioning system 508 may be configured as a KAFKA® consumer provided by APACHE® KAFKA® open-source software in order to receive or retrieve real-time updates of the primary data stored in the primary data storage subsystem 506. To provide a specific example, a KAFKA® source connector may be utilized to monitor tables and/or columns in the primary data storage subsystem 506 for primary data updates (e.g., primary data additions, primary data removals, primary data updates, etc.), and custom queries may be provided in the KAFKA® connector configuration to filter the results so that only desired tables and/or columns are retrieved, so that confidential data such as PII is ignored, etc.

In another example, the primary data storage subsystem 506 may not be configured with the CDC subsystem discussed above, and the backup data notification engine 514 in the backup data conversion/analytics data provisioning system 508 may be configured with permissions for the primary data storage subsystem 506 that allow it to access a primary data transaction log such as a query log in the primary data storage subsystem 506 that may be used to identify updates of the primary data stored in the primary data storage subsystem 506 (e.g., a backup-initiated timestamp may be utilized along with a “cron” job to retrieve all primary data updates executed in the primary data storage subsystem 506 following that backup-initiated timestamp that may identify the most recent full restore operation or incremental restore operation). However, while two specific examples of configurations that allow the backup data conversion/analytics data provisioning system 508 to monitor whether the primary data in the primary data storage subsystem 506 has been updated, one of skill in the art in possession of the present disclosure will appreciate how other primary data update identification techniques will fall within the scope of the present disclosure as well.

In the illustrated embodiment, if at decision block 608 it is determined that the primary data in the primary data storage subsystem has not been updated, the method 600 proceeds to decision block 612, discussed in further detail below. However, while method 600 is illustrated as proceeding to decision block 612 to monitor for analytics data requests following a determination that primary data in the primary data storage subsystem 506 has not been updated, one of skill in the art in possession of the present disclosure will appreciate that decision block 608 of the method 600 may loop for any primary data that was converted to analytics data in order to ensure that any analytics data converted from primary data remains “up-to-date” in the analytics data storage subsystem 520 with regard to that primary data (i.e., so that the analytics data in the analytics data storage subsystem 520 is the same or similar to the primary data in the primary data storage subsystem 506 (but with different file formats)).

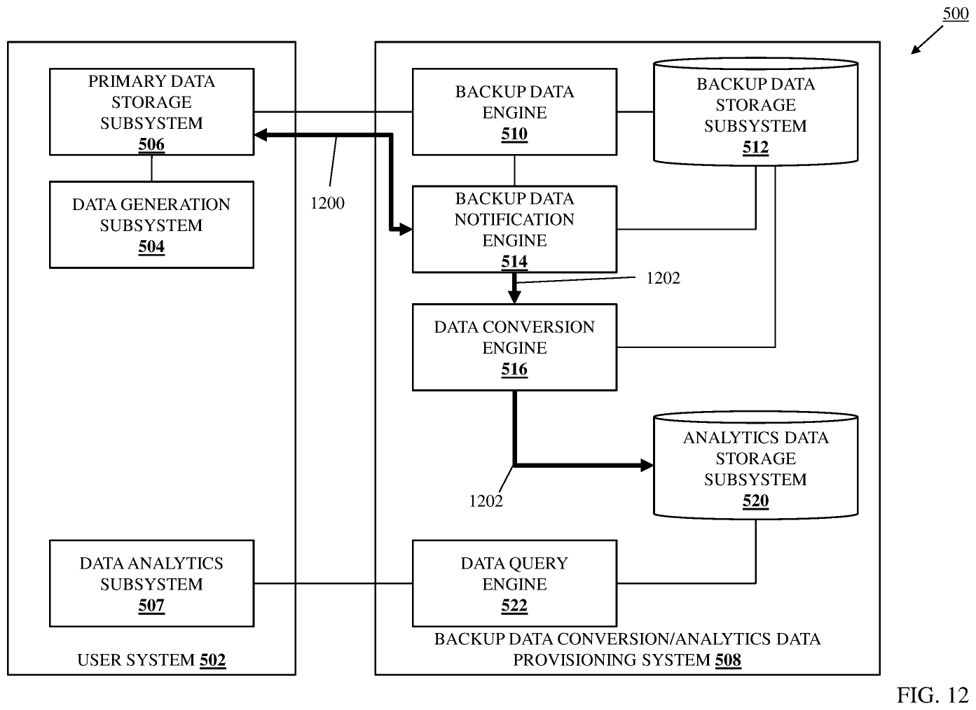

If, at decision block 608, it is determined that the primary data in the primary data storage subsystem has been updated, the method 600 proceeds to block 610 where the backup data conversion/analytics data provisioning subsystem updates analytics data in the analytics data storage subsystem. With reference to FIG. 12, in an embodiment of decision block 608, the backup data notification engine 514 in the backup data conversion/analytics data provisioning system 508 may perform primary data update identification operations 1200 that may include identifying an update to the primary data in the primary data storage subsystem 506. For example, as discussed above, the backup data notification engine 514 in the backup data conversion/analytics data provisioning system 508 operating as a KAFKA® consumer may receive or retrieve primary update data communications from the primary data storage subsystem 506 that identify real-time updates of the primary data stored in the primary data storage subsystem 506 as part of the primary data update identification operations 1200. In another example, and also as discussed above, the backup data notification engine 514 in the backup data conversion/analytics data provisioning system 508 may access a primary data transaction log such as a query log in the primary data storage subsystem 506, and use that query log to identify updates of the primary data stored in the primary data storage subsystem 506. However, while two specific examples of identifying that the primary data in the primary data storage subsystem 506 has been updated has been described, one of skill in the art in possession of the present disclosure will appreciate how other primary data update identification techniques will fall within the scope of the present disclosure as well.

With continued reference to FIG. 12, the backup data notification engine 514 and the data conversion engine 516 in the backup data conversion/analytics data provisioning system 508 may then perform analytics data update operations 1202 that may include the backup data notification engine 514 identifying the primary data update to the data conversion engine 516, and the data conversion engine 516 then updating the analytics data in the analytics data storage subsystem 520. Continuing with the example above in which the backup data notification engine 514 in the backup data conversion/analytics data provisioning system 508 operates as a KAFKA® consumer, the CDC subsystem in the primary data storage subsystem 506 may stream the primary data updates (e.g., using an ORACLE® GOLDEN GATE® data streaming subsystem and via a KAFKA® connect API) to the backup data notification engine 514/data conversion engine 516, with the backup data notification engine 514/data conversion engine 516 identifying a queries (e.g., an insert query, an update query, a delete query, etc.) from the primary data update, converting the queries to an ICEBERG® query format (e.g., from a primary data format), and applying the queries having the ICEBERG® query format to the analytics data storage subsystem 520 in order to update the analytics data.

Continuing the example above in which the backup data notification engine 514 in the backup data conversion/analytics data provisioning system 508 uses the query log from the primary data storage subsystem 506 to identify updates of the primary data stored in the primary data storage subsystem 506, the backup data notification engine 514/data conversion engine 516 may identify the queries from the query log, apply one or more query filters to those queries in order to extract queries of interest, convert those queries of interest to an ICEBERG® query format (e.g., from a raw/native SQL query to a SPARK®-SQL query format in situations where DML queries utilized in the system follow a conventional American National Standards Institute (ANSI) SQL syntax that is also utilized in ICEBERG® queries), and apply the queries having the ICEBERG® query format to the analytics data storage subsystem 520 (e.g., execute ICEBERG® format queries as part of SPARK®-SQL operations) in order to update the analytics data. However, while two specific examples of updating the analytics data in the analytics data storage subsystem 520 in response to updates to the primary data in the primary data storage subsystem 506 have been described, one of skill in the art in possession of the present disclosure will appreciate how other primary data/analytics data update techniques will fall within the scope of the present disclosure as well.

The method 600 then proceeds to decision block 612 where it is determined whether an analytics request has been received from a data analytics subsystem. However, similarly as discussed above, while the method 600 illustrated in FIG. 6 follows the update of the analytics data at block 610 to monitor for analytics data requests, decision block 608 and block 610 may loop for any primary data that was converted to analytics data in order to ensure that any analytics data converted from primary data remains “up-to-date” in the analytics data storage subsystem 520 with regard to that primary data (i.e., so that the analytics data in the analytics data storage subsystem 520 is the same or similar to the primary data in the primary data storage subsystem 506 (but with different file formats)).

In an embodiment, at decision block 612, the data query engine 522 in the backup data conversion/analytics data provisioning system 508 may operate to monitor whether the data analytics subsystem 507 in the user system 502 provides a request for the analytics data in the analytics data storage subsystem 520. As discussed in further detail below, following its storage in the analytics data storage subsystem 520, the analytics data may be available for utilization by data analytics applications and/or other subsystems such as the data analytics subsystem 507 for use in performing data analytics operations, and the data query engine 522 may be configured to satisfy any requests for that analytics data by, for example, receiving an analytics request from the data analytics subsystem 507, validating a user of the data analytics subsystem 507, and/or performing other data access operations that would be apparent to one of skill in the art in possession of the present disclosure.

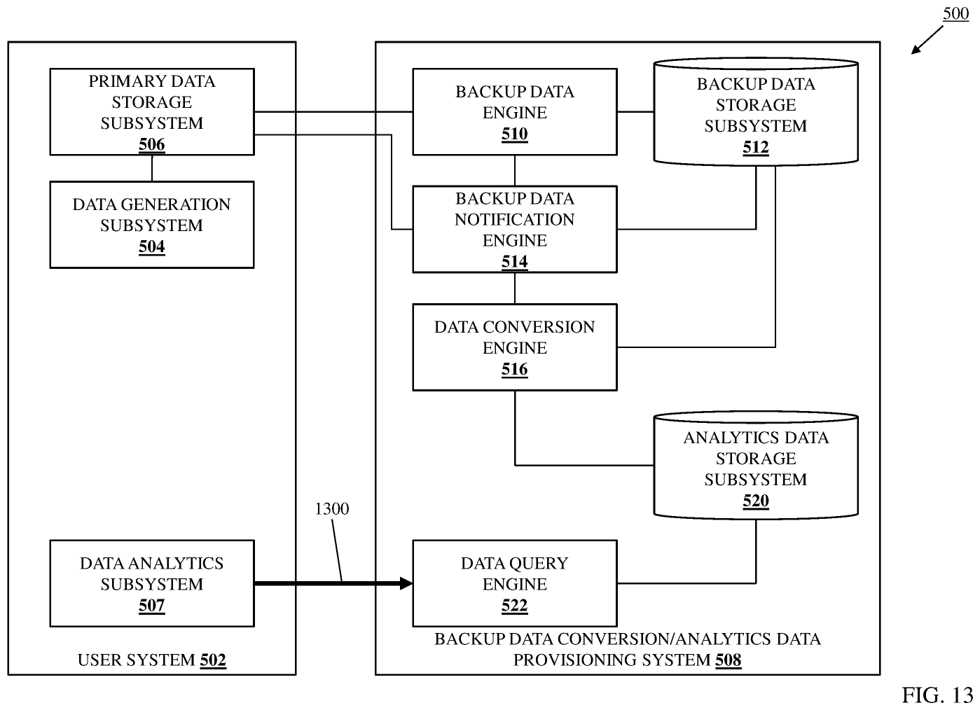

If, at decision block 612, it is determined that an analytics request has not been received from the data analytics subsystem, the method 600 returns to decision block 602. As such, the method 600 may loop such that backup data is converted to analytics data following its provisioning by the user system 502 in the backup data storage subsystem 512, and then stored in the analytics data storage subsystem 520 (and updated in response to updates of corresponding primary data in the primary data storage subsystem 506) until an analytics request is received from the data analytics subsystem 507. If at decision block 612, it is determined that an analytics request has been received from a data analytics subsystem, the method 600 proceeds to block 614 where the backup data conversion/analytics data provisioning subsystem provides the analytics data to the data analytics subsystem. With reference to FIG. 13, in an embodiment of decision block 612, the data analytics subsystem 507 in the user system 502 may perform data analytics request operations 1300 that may include generating and transmitting a data analytics request to the data query engine 522 in the backup data conversion/analytics data provisioning system 508, and one of skill in the art in possession of the present disclosure will appreciate how that analytics request may identify any of a variety of analytics data for any analytics operations that may include predictive analytic operations, data mining analytics operations, machine learning analytic operations, security analytic operations (e.g., PII security analytic operations, regulatory compliance analytic operations, etc.), and/or other analytics operations that would be apparent to one of skill in the art in possession of the present disclosure. As such, the data query engine 522 may determine at decision block 612 that an analytics request has been received, and the method 600 may proceed to block 614.

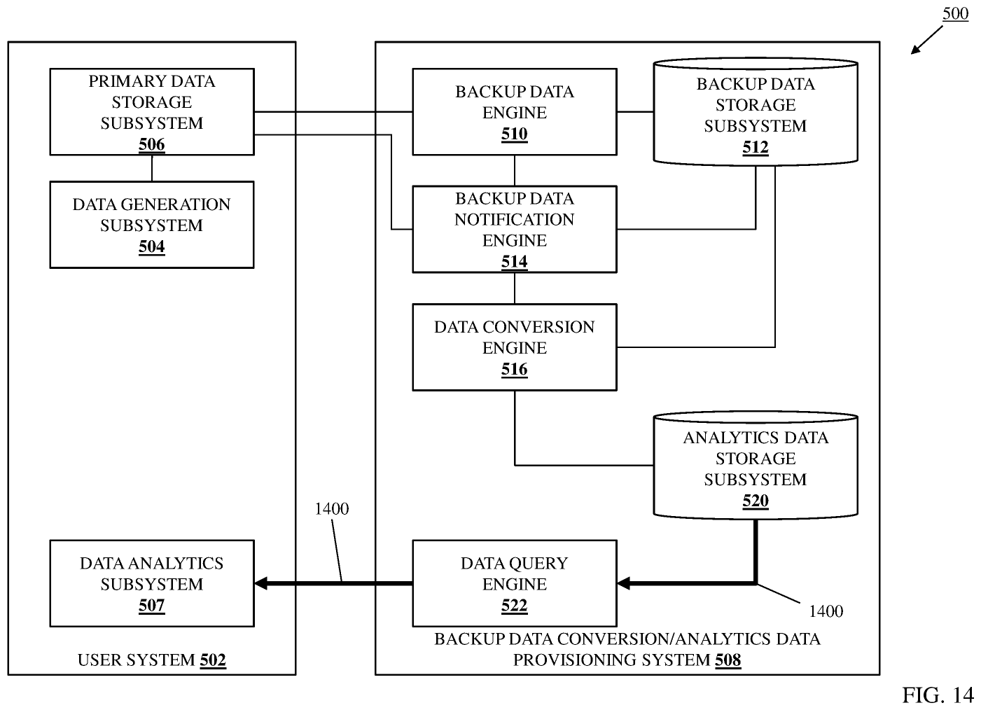

With reference to FIG. 14, in an embodiment of block 614 and in response to receiving the analytics request, the data query engine 522 in the backup data conversion/analytics data provisioning system 508 may perform analytics data provisioning operations 1400 that may include retrieving the analytics data identified in the analytics request from the analytics data storage subsystem 520, and then transmitting that analytics data to the data analytics subsystem 507 in the user system 502. As will be appreciated by one of skill in the art in possession of the present disclosure, following the receiving of the analytics data, the data analytics subsystem 507 in the user system 502 may utilize that analytics data to perform predictive analytic operations, data mining analytics operations, and/or a variety of other analytics operations that would be apparent to one of skill in the art in possession of the present disclosure. The method 600 then returns to decision block 602. As such, the method 600 may loop to convert backup data provided in a backup data storage subsystem to analytics data and store that analytics data in an analytics data storage subsystem, while updating that analytics data in response to updates to corresponding primary data in a primary data storage subsystem, while making the analytics data (which may provide a full/entire/complete copy of the primary data) available to a data analytics subsystem.

As will be appreciated by one of skill in the art in possession of the present disclosure, conventional primary data storage subsystems in conventional user systems typically include proprietary compute systems that are not configured to enable the addition or removal of compute “on-demand”, and thus additional compute resources are often required in such primary data storage subsystem/user system in order to enable conventional data analysis operations, which can increase the compute licensing costs associated with the primary data storage subsystem/user system. However, one of skill in the art in possession of the present disclosure will appreciate how the backup data analysis system of the present disclosure reduces the compute resource requirements needed for data analysis in the user system 502, and allows the compute resource needs for the analytics data (e.g., compute resources required to prepare the analytics data for analytics operations, etc.) to grow separately from the compute resource needs of the user system. As such, the systems and methods of the present disclosure allow for a “Bring Your Own Compute” data analysis paradigm, accelerating analytics data processing while reducing or even eliminating conventional data analysis issues such as the analytics operation latency discussed above, while enabling parallel computing on the primary/analytics data, allowing dynamic sizing/expansion planning for the analytics system, and providing other benefits that would be apparent to one of skill in the art in possession of the present disclosure.

As such, backup data that is generated from primary data and stored as part of data protection strategies in practically all user systems may be leverage not only in data disaster scenarios, but also to enable the analysis of historical data sets, transactional data sets, and/or other data sets included in the primary data by converting the backup data from a backup file format that is not conventionally readable by data analysis subsystems to an open file format that is accessible via queries provided using APIs and/or other techniques available in many data analysis subsystems.

Thus, systems and methods have been described that provide for the conversion of backup data, which is stored in a backup data storage subsystem in order to back up primary data stored in a primary data storage subsystem, to analytics data that is stored in an analytics data storage subsystem for use in performing analytics operations. For example, the backup data analysis system of the present disclosure may include a data generation subsystem that generates primary data, a primary data storage subsystem that stores the primary data, and a backup data storage subsystem that stores backup data that has a backup file format and that is a backup of the primary data. At least one backup data conversion/analytics data provisioning subsystem is coupled to a data analytics subsystem, an analytics data storage subsystem, and the backup data storage subsystem, and retrieves the backup data from the backup data storage subsystem, converts the backup data from the backup file format to an open file format to provide analytics data, and stores the analytics data in the analytics data storage subsystem. When the backup data conversion/analytics data provisioning subsystem(s) receive an analytics data request from the data analytics subsystem, they provide the analytics data to the analytics data subsystem for use in analytics operation(s). As such, backup data that includes a complete copy of primary data in a user system may be utilized in analytics operations to increase the accuracy and value of corresponding analytics, while not effecting the use of the primary data in the user system.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A backup data analysis system, comprising:
a data generation subsystem that is configured to generate primary data;
a primary data storage subsystem that is coupled to the data generation subsystem and that is configured to store the primary data generated by the data generation subsystem;
a backup data storage subsystem that is coupled to the primary data storage subsystem and that is configured to store backup data that has a backup file format and that is a backup of the primary data stored in the primary data storage subsystem;
a data analytics subsystem;
an analytics data storage subsystem;
at least one backup data conversion/analytics data provisioning subsystem that is coupled to the data analytics subsystem, the backup data storage subsystem, and the analytics data storage subsystem, wherein the at least one backup data conversion/analytics data provisioning subsystem is configured to:
retrieve the backup data from the backup data storage subsystem;
convert the backup data from the backup file format to an open file format to provide analytics data;
store the analytics data in the analytics data storage subsystem;
receive, from the data analytics subsystem, an analytics data request; and
provide, to the data analytics subsystem in response to receiving the data analytics request, the analytics data, wherein the data analytics subsystem is configured to:
perform at least one analytics operation on the analytics data.

2. The system of claim 1, wherein the data generation subsystem, the primary data storage subsystem, and the data analytics subsystem are included in a user system that is coupled via a network to a backup data conversion/analytics data provisioning system that includes the backup data storage subsystem, the analytics data storage subsystem, and the at least one backup data conversion/analytics data provisioning subsystem.

3. The system of claim 1, wherein the converting the backup data from the backup file format to the open file format to provide the analytics data includes:
converting the backup data from the backup file format to a comma separated value file format to provide intermediate data; and
converting the intermediate data from the comma separated value file format to the open file format to provide the analytics data.

4. The system of claim 1, wherein the at least one backup data conversion/analytics data provisioning subsystem is configured to:
initiate a primary data storage subsystem backup operation that converts the primary data stored on the primary data storage subsystem to the backup data, and stores the backup data on the backup data storage subsystem.

5. The system of claim 1, wherein the at least one backup data conversion/analytics data provisioning subsystem is configured to:
receive, from the primary data storage subsystem, a primary data update communication that identify a primary data update to the primary data stored in the primary data storage subsystem; and
update, based on the primary data update, the analytics data in the analytics data storage subsystem.

6. The system of claim 1, wherein the at least one backup data conversion/analytics data provisioning subsystem is configured to:
retrieve, from the primary data storage subsystem, a primary data transaction log;
identify, using the primary data transaction log, a primary data update to the primary data stored in the primary data storage subsystem; and
update, based on the primary data update, the analytics data in the analytics data storage subsystem.

7. An Information Handling System (IHS), comprising:
a processing system; and
a memory system that is coupled to the processing system and that includes instructions that, when executed by the processing system, cause the processing system to provide a backup data conversion/analytics data provisioning engine that is configured to:
retrieve, from a backup data storage subsystem, backup data that has a backup file format and that is a backup of primary data stored in a primary data storage subsystem;
convert the backup data from the backup file format to an open file format to provide analytics data;
store the analytics data in an analytics data storage subsystem;
receive, from a data analytics subsystem, an analytics data request; and
provide, to the data analytics subsystem in response to receiving the data analytics request, the analytics data.

8. The IHS of claim 7, wherein the processing system is coupled via a network to a user system that includes the primary data storage subsystem and the data analytics subsystem.

9. The IHS of claim 7, wherein the converting the backup data from the backup file format to the open file format to provide the analytics data includes:
converting the backup data from the backup file format to a comma separated value file format to provide intermediate data; and
converting the intermediate data from the comma separated value file format to the open file format to provide the analytics data.

10. The IHS of claim 7, wherein the at least one backup data conversion/analytics data provisioning engine is configured to:
initiate a primary data storage subsystem backup operation that converts the primary data stored on the primary data storage subsystem to the backup data, and stores the backup data on the backup data storage subsystem.

11. The IHS of claim 7, wherein the at least one backup data conversion/analytics data provisioning engine is configured to:
receive, from the primary data storage subsystem, a primary data update communication that identify a primary data update to the primary data stored in the primary data storage subsystem; and
update, based on the primary data update, the analytics data in the analytics data storage subsystem.

12. The IHS of claim 7, wherein the at least one backup data conversion/analytics data provisioning engine is configured to:
retrieve, from the primary data storage subsystem, a primary data transaction log;
identify, using the primary data transaction log, a primary data update to the primary data stored in the primary data storage subsystem; and
update, based on the primary data update, the analytics data in the analytics data storage subsystem.

13. The IHS of claim 7, wherein the analytics data having the open file format is provided in an open table format data file.

14. A method for providing backup data analysis, comprising:
retrieving, by a backup data conversion/analytics data provisioning subsystem from a backup data storage subsystem, backup data that has a backup file format and that is a backup of primary data stored in a primary data storage subsystem;
converting, by the backup data conversion/analytics data provisioning subsystem, the backup data from the backup file format to an open file format to provide analytics data;
storing, by the backup data conversion/analytics data provisioning subsystem, the analytics data in an analytics data storage subsystem;
receiving, by the backup data conversion/analytics data provisioning subsystem from a data analytics subsystem, an analytics data request; and
providing, by the backup data conversion/analytics data provisioning subsystem to the data analytics subsystem in response to receiving the data analytics request, the analytics data.

15. The method of claim 14, wherein the backup data conversion/analytics data provisioning subsystem is coupled via a network to a user system that includes the primary data storage subsystem and the data analytics subsystem.

16. The method of claim 14, wherein the converting the backup data from the backup file format to the open file format to provide the analytics data includes:
converting the backup data from the backup file format to a comma separated value file format to provide intermediate data; and
converting the intermediate data from the comma separated value file format to the open file format to provide the analytics data.

17. The method of claim 14, further comprising:
initiating, by the backup data conversion/analytics data provisioning subsystem, a primary data storage subsystem backup operation that converts the primary data stored on the primary data storage subsystem to the backup data, and stores the backup data on the backup data storage subsystem.

18. The method of claim 14, further comprising:
receiving, by the backup data conversion/analytics data provisioning subsystem from the primary data storage subsystem, a primary data update communication that identify a primary data update to the primary data stored in the primary data storage subsystem; and
updating, by the backup data conversion/analytics data provisioning subsystem based on the primary data update, the analytics data in the analytics data storage subsystem.

19. The method of claim 14, further comprising:
retrieving, by the backup data conversion/analytics data provisioning subsystem from the primary data storage subsystem, a primary data transaction log;
identifying, by the backup data conversion/analytics data provisioning subsystem using the primary data transaction log, a primary data update to the primary data stored in the primary data storage subsystem; and
updating, by the backup data conversion/analytics data provisioning subsystem based on the primary data update, the analytics data in the analytics data storage subsystem.

20. The method of claim 14, wherein the analytics data having the open file format is provided in an open table format data file.
